(19) United States
(12) Patent Application Publication
(10) Pub. No.: US 2004/0236453 A1
(43) Pub. Date: Nov. 25, 2004

(54) Method and apparatus for combining and generating trajectories

(76) Inventor: Gabor Szoboszlay, Santa Clara, CA (US)

Correspondence Address: Law Office Of Leland Wiesner, 1144 Fife Ave., Palo Alto, CA, 94301, US

(21) Appl. No.: 10/444,919

(22) Filed: May 22, 2003

(51) Int. Cl. G06F 19/00

(52) U.S. Cl. 700/121; 700/69; 700/63

(57) ABSTRACT

An apparatus and method for generating a trajectory used in precision lithography, includes receiving first input parameters for a first trajectory and second input parameters for a second trajectory, converting the first input parameters of the first trajectory into a first derivative-jerk and the second input parameters of the second trajectory into a second derivative-jerk. The first and second derivative-jerk are arranged with the first derivative-jerk overlapping the second derivative-jerk by a time interval, and then combining the first derivative-jerk and the second derivative-jerk together into a third derivative-jerk using a shorter period of time compared with the time to finish the combination of the first derivative-jerk and the second derivative-jerk.

### TECHNICAL FIELD

This invention relates to a method and apparatus for generating complex trajectories for use in microlithography and manufacture of microelectronic devices and other precision manufacturing technologies.

### BACKGROUND

Microlithographic systems used in semiconductor processing and other high precision positioning applications need smooth stage motion to minimize the amount of structural vibration or oscillation in the system's structure. While many conventional positioning systems have anti-vibration devices in an attempt to minimize these disturbances, the unavoidable acceleration and deceleration of the stage produces forces on the positioning system and contributes to small oscillations of the positioning system's structure.

The stage moves according to a trajectory described by position, velocity, acceleration, and “jerk” movements of the system's stage during a conventional scan and exposure. During the exposure, the stage moves at a constant velocity while an energy beam scans and exposes the substrate. After the exposure, the stage accelerates to get to the next area to be exposed and then decelerates to a constant velocity to begin the exposure.

Jerk is the derivative of acceleration with respect to time and may include discontinuities. Unfortunately, discontinuities in the Jerk correspond to abrupt motions on the stage and often contribute to vibrating the stage and system structure. Moreover, a large jerk at the beginning and end of the acceleration and deceleration of the stage produces a large reactive force that excites the positioning system's structure and creates larger oscillations. Accordingly, the vibrations or oscillations in a positioning system, such as a microlithography machine, will have a deleterious effect on systems designed to position stages with sub-micron accuracy.

To minimize the vibration due to these rapid accelerations and decelerations, a settling period is introduced between exposures during which the oscillations generated during the acceleration/deceleration of the stage are allowed to dissipate. Consequently, in a conventional positioning system in which oscillations occur, trajectories include one or more settling periods to reduce the effect of vibrations.

Time spent during the settling period not only reduces the effects of acceleration but also reduces the throughput of the overall system. In some trajectories, a longer settling period may be selected to ensure that the vibrations have dissipated and the system is ready for the next exposure. Conventional systems may use longer settling periods also because of the complexity and difficulty in accurately determining the minimum settling time period. For example, imperfections in the wafer or system as well as variations in temperature can influence the length of the settling period required for vibrations to dissipate.

Conventional systems also cannot change the trajectory or reduce the settling period during processing. Complex calculations used to calculate the trajectory make it prohibitively slow for conventional systems to recalculate a settling period or change the shape of the trajectory during exposure. Even if a settling period during the course of a trajectory could be reduced, these conventional systems cannot operate quickly enough to modify the trajectory appropriately and increase overall throughput of the system.

### SUMMARY OF THE INVENTION

One aspect of the invention describes a method for generating a trajectory used in precision lithography, comprising receiving first input parameters for a first trajectory and second input parameters for a second trajectory, converting the first input parameters of the first trajectory into a first derivative-jerk and the second input parameters of the second trajectory into a second derivative-jerk, arranging the first derivative-jerk to overlap the second derivative jerk by a time interval and reduce the time period for performing the first trajectory and second trajectory, and combining the first derivative-jerk and the second derivative-jerk together into a third derivative-jerk that uses a smaller time interval than required separately by the first derivative-jerk and the second derivative-jerk.

Another aspect of the invention includes an exposure apparatus that exposes a substrate during processing having an energy emission system that forms an image on a substrate, a substrate stage that supports the substrate and moves the substrate along one or more axes relative to the energy emission system, an actuator operatively connected to the substrate stage that moves the substrate stage in response to controller signals corresponding to a trajectory, and a controller operatively connected to the actuator that generates the trajectory by receiving first input parameters for a first trajectory and second input parameters for a second trajectory, converting the first input parameters of the first trajectory into a first derivative-jerk and the second input parameters of the second trajectory into a second derivative-jerk, and combining the first derivative-jerk and the second derivative-jerk together into a third derivative-jerk that modifies the first trajectory and the second trajectory. The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a schematic view illustrating a photolithographic instrument that uses a trajectory generated in accordance with implementations of the present invention;

FIG. 2 is a block diagram of operations associated with generating a trajectory to move a stage and receiving feedback information in accordance with one implementation of the present invention;

FIG. 3 is a block diagram schematic depicting the components associated with generating a trajectory from individual trajectories in accordance with one implementation of the present invention;

FIG. 4 is a flow chart diagram of the operations associated with combining individual trajectories into a resultant trajectory for moving a stage in accordance with one implementation of the present invention;

FIG. 5A includes charts representing the derivative of Jerk (Djerk) and Jerk components for a trajectory generated in accordance with one implementation of the present invention;

FIG. 5B includes charts representing the acceleration and velocity components for a trajectory generated in accordance with one implementation of the present invention;

FIG. 5C includes a chart representing the position component of a trajectory generated in accordance with one implementation of the present invention;

FIG. 6 is a flow chart diagram outlining the operations used for manufacturing a device in accordance with implementations of the present invention; and

FIG. 7 is a flow chart diagram further detailing the operations associated with device manufacturing in accordance with implementations of the present invention.

### DETAILED DESCRIPTION

Implementations of the present invention generate a trajectory from a combination of individual trajectories for use during lithographic processing and other types of precision manufacturing. Pairs of individual trajectories are modified as needed and added together as vectors to incrementally create the overall trajectory during processing. Instead of creating one monolithic trajectory in advance, complex trajectories can be generated based on the summation of many smaller individual trajectories. This not only provides flexibility in generating the trajectory but can also be used to improve the throughput time associated with exposing a semiconductor wafer to a complex exposure.

Both the individual and combined trajectories can be generated and modified dynamically as a stage moves during lithography or other types of processing. Modifications can be made to the individual trajectories without recalculating a final trajectory. Having the ability to incrementally modify a trajectory has many different advantages. In one application, implementations of the present invention are used to overlap adjacent individual trajectories and reduce turnaround times as well as modify the overall shape and characteristic of the trajectory. Overlapping the deceleration of one shot with the acceleration of a subsequent adjacent shot reduces the times for processing the information. For example, overlapping adjacent individual trajectories reduces the settling time spent between exposures of a semiconductor wafer. Other modifications of the trajectory can also be achieved through other vector operations and modifications of underlying smaller trajectories in accordance with implementations of the present invention. These and other advantages may be realized in accordance with implementations of the present invention described and illustrated herein.

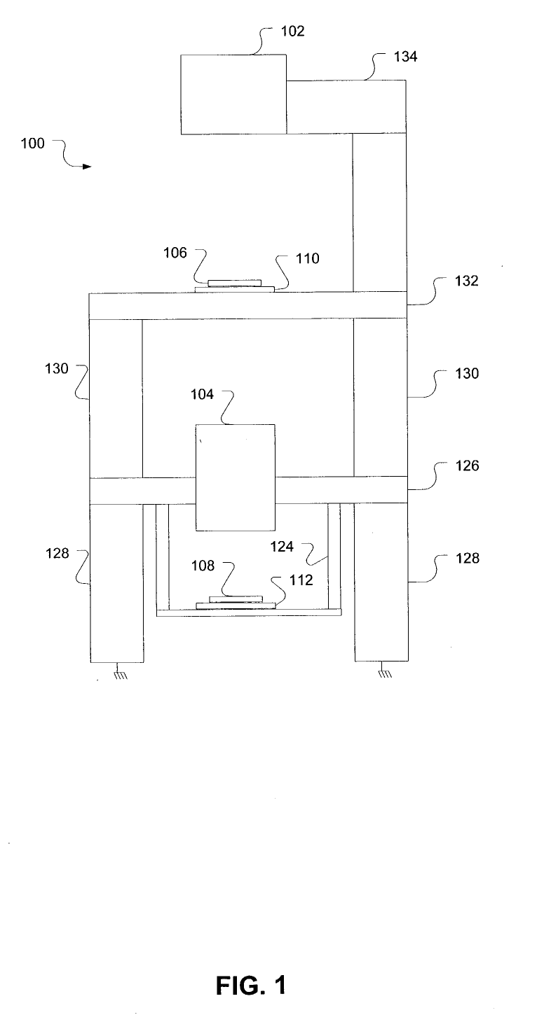

A brief description of a photolithographic instrument is provided as background and application of trajectory generation in accordance with implementations of the present invention. FIG. 1 is a schematic view illustrating a photolithographic instrument using a trajectory generated in accordance with implementations of the present invention. The trajectory is an output vector with a combination of four values including position, velocity, acceleration, and jerk (e.g., the derivative of acceleration). In one implementation on the present invention, vector addition is performed on a fourth-order position trajectory otherwise referred to as the derivative of the jerk component. Using vector addition on these higher order derivatives reduces discontinuities in the lower order trajectory components like acceleration, velocity, and position as they drive a stage during an exposure.

The view in FIG. 1 illustrates a photolithographic instrument 100 incorporating a wafer positioning stage driven by a linear motor coil array or planar motor coil array. Photolithographic instrument 100 generally includes an illumination system 102 and at least one linear or planar motor for wafer support and positioning. Illumination system 102 projects radiant energy (e.g. light) through a mask pattern (e.g., a circuit pattern for a semiconductor device) on a reticle (mask) 106 that is supported by and scanned using a reticle stage (mask stage) 110. Reticle stage 110 is supported by a frame 132. The radiant energy is focused through a projection optical system (lens system) 104 supported on a frame 126, which is in turn anchored to the ground through a support 128. Optical system 104 is also connected to illumination system 102 through frames 126, 130, 132 and 134. The radiant energy exposes the mask pattern onto a layer of photoresist on a wafer 108.

Wafer (object) 108 is supported by and scanned using a fine wafer stage 112. Fine stage 112 is limited in travel to about 400 microns total stroke in each of the X and Y directions. Implementations of the present invention can be used to generate trajectories used by fine stage 112, reticle stage 110, or any other stage moving a wafer or other object in semiconductor lithography or other precision manufacturing.

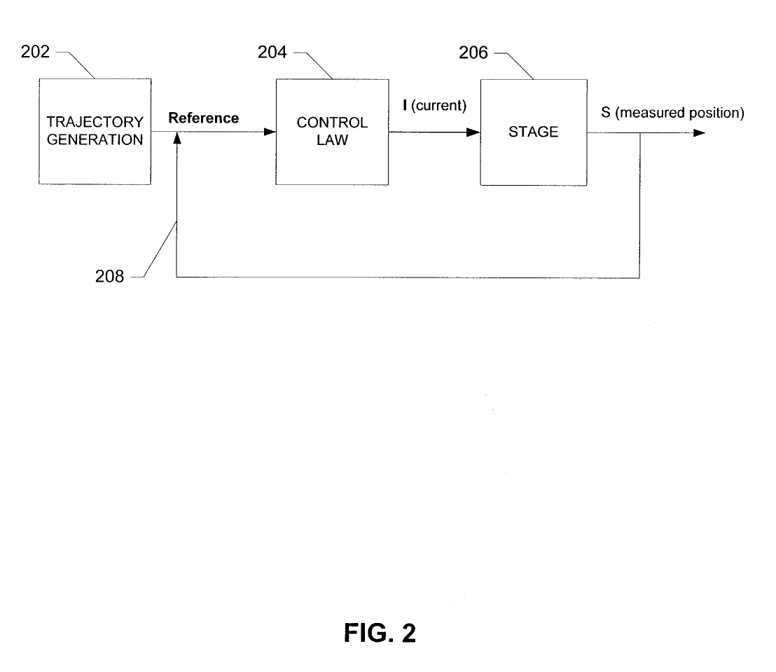

FIG. 2 is a schematic of the components for driving a stage along a trajectory generated in accordance with implementations of the present invention. The trajectory generally describes a path for moving one or more stages while exposing a wafer or other objects. As previously described, the trajectory can be described as an output vector describing position, velocity, acceleration, and jerk to move one or more stages while exposing the wafer or other objects. The trajectory vector may include multiple axes including X, Y, Z, Theta-X, Theta-Y, Theta-Z, and combinations thereof. Theta-X, Theta-Y, and Theta-Z indicate a rotation about the X, Y, and Z axes respectively.

A trajectory component 202 combines one or more pairs of individual trajectories in accordance with the present invention into a reference trajectory for exposing the wafer or other objects to the light or energy beams produced by the optical system. This reference trajectory from trajectory generation component 202 is provided to a control law component 204 and compared with a sensor signal S 208 produced by various interferometer devices measuring the actual position of the stage. The differential between the reference trajectory and the actual trajectory as measured by the interferometer may vary throughout the exposure.

Control law component 204 uses the resulting differential to prescribe a corrective action signal (I) for stage component 206 to follow. The resulting differential may also be used by implementations of the present invention to alter the shape and use of the individual trajectories being combined by trajectory generation component 202. Control law component 204 can operate as a PID (proportional integral derivative) controller, proportional gain controller or preferably a lead-lag filter, or follow other control laws well known in the art of control, for example.

Stage component 206 responds to the corrective action signal (I) input by moving the stage along the trajectory. Typically, an actuator is connected to the substrate stage and causes the stage to move the substrate stage in response to control law signals for the trajectory. Repeated measurements of the position of the sensor frame with various interferometer devices are made until the trajectory is completed. Additional processing and components may also be used but have been omitted for purposes of clarity in describing aspects of the present invention.

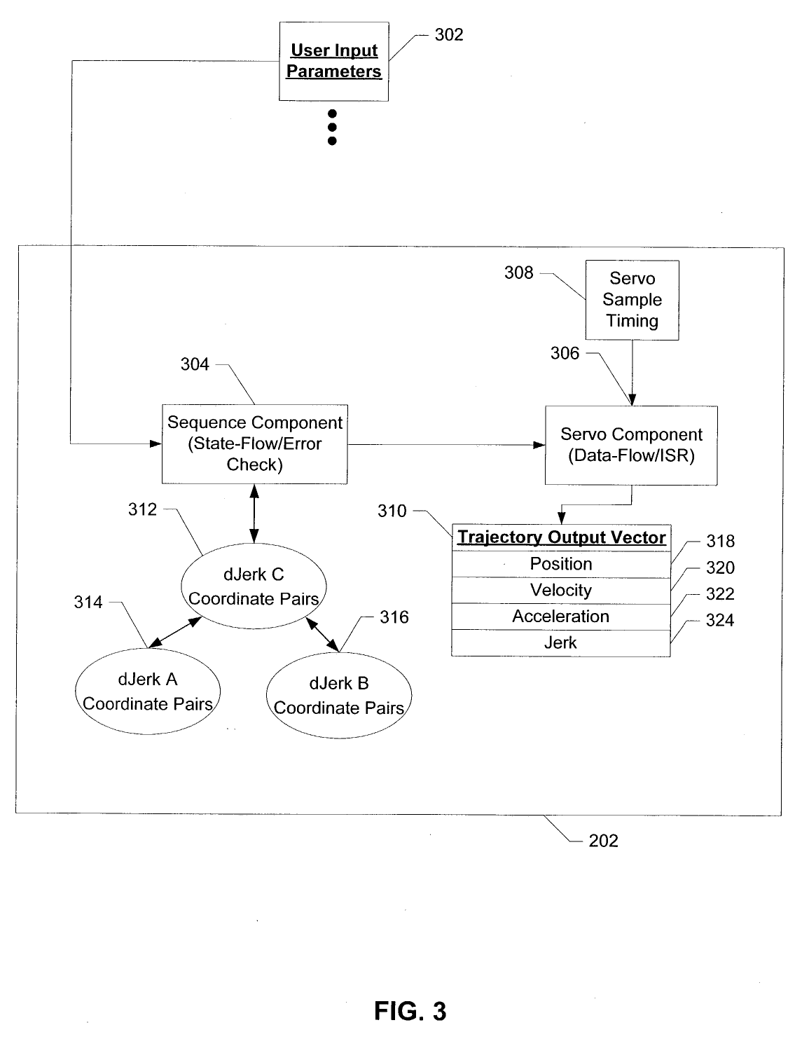

FIG. 3 is a schematic block diagram of the components used by implementations of the present invention for combining pairs of individual trajectories into larger more complex trajectories. Trajectory generation component 202 includes a sequence component 304, a servo component 306, a servo sample timing component 308, a trajectory output vector 310, and dJerk A 314, dJerk B 316, and dJerk C 312 coordinate pairs.

User input parameters 302 are provided by a user and describe various aspects of the trajectory. These user input parameters 302 may include maximum speed, maximum acceleration, starting position, destination position, scanning velocity, acceleration position or any other parameters that helps describe the individual trajectories. Sequence component 304 converts user input parameters 302 into a set of djerk-time coordinate pairs, as provided by the following example vector of djerk-time pairs:

dJerk={(dJ₀, t₀), (dJ₁, t₁), (dJ₂, t₂), . . . (dJ₇, t₇), . . . }

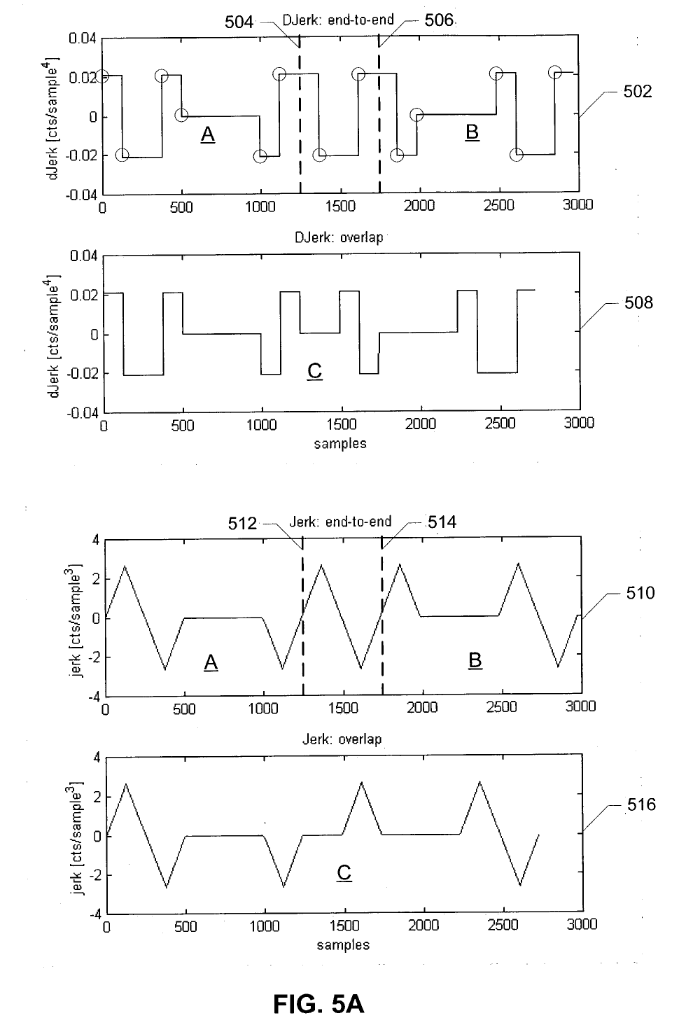

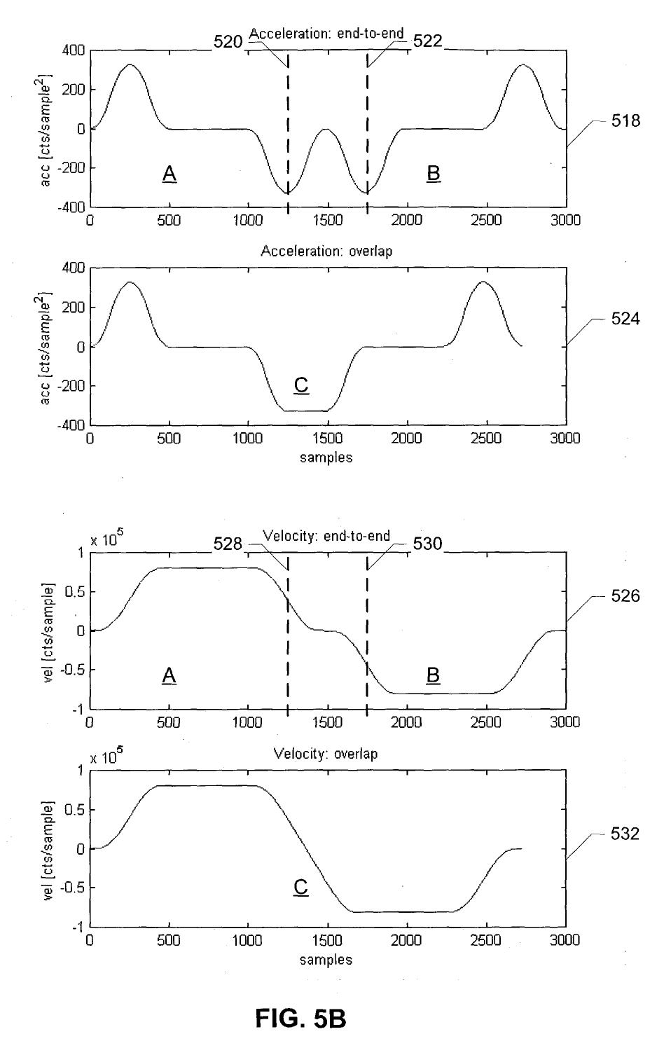

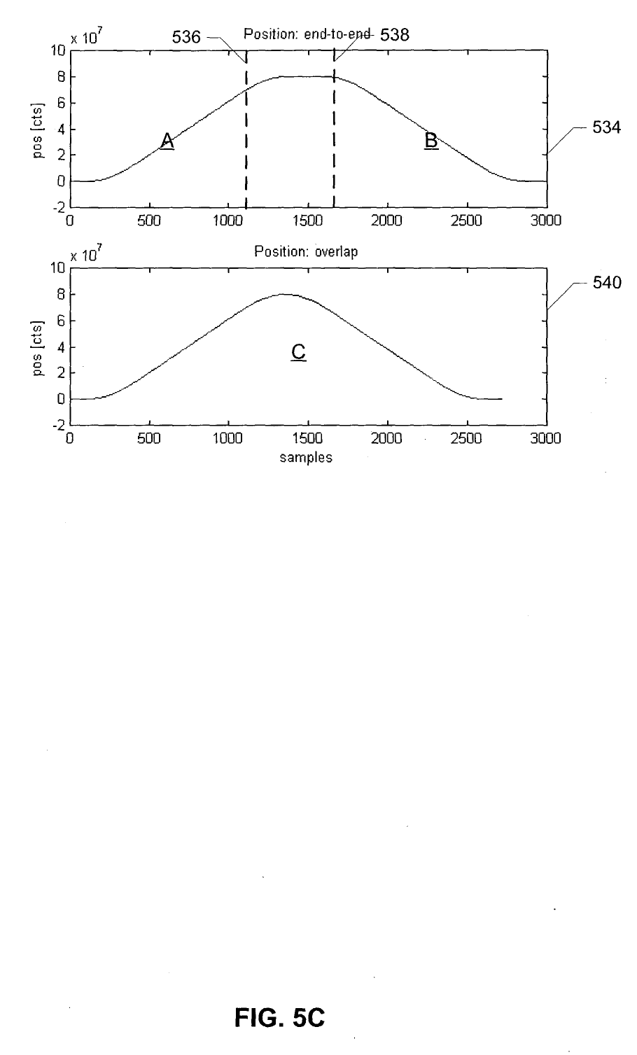

In one implementation, the dJerk trajectory component may be defined using a minimum set of points (indicated by circles on dJerk graph 502 in FIG. 5). These points correspond to the djerk-time coordinate pairs, and at least in one implementation correspond to an underlying square-wave function (see dJerk graph 502 in FIG. 5). For example, 13 djerk-time coordinate pairs can be used to define at least 12 horizontal segments of a square-wave function as indicated in dJerk graph 502 in FIG. 5. The small number of coordinate pairs used to define the dJerk component reduces storage requirements especially when compared to the alternatives. For example, implementations of the present invention have less storage requirements than required for capturing the many thousands of servo samples taken over an equivalent time period for underlying data components of the trajectory curve (e.g., position, velocity and acceleration components). Rather than storing these values, implementations of the present invention integrates dJerk one or more times to obtain these trajectory curves and values.

Sequence component 304 performs vector addition in accordance with one implementation of the present invention to combine dJerk A coordinate pairs 314 and dJerk B coordinate pairs 316 into a combined dJerk C coordinate pairs 312. Error checking by sequence component 304 on the resulting dJerk C coordinate pairs 312 includes verifying that the dJerk C coordinate pairs 312 are in chronological order and that only one dJerk value is associated with a particular time interval. Performing these and other error checking operations by sequence component 304 off-loads the processing from other components later in the process. In particular, this enables servo component 306 to operate with minimal delay as it controls servos in various portions of the equipment.

To obtain each of the trajectory components, servo component 306 may also perform one or more integrations on dJerk using the djerk-time coordinate pairs provided by sequence component 304. DJerk-time coordinate pairs are double-buffered internally thereby enabling both sequence component 304 and servo component 306 to have access to their own set of variables. For example, the internal buffering enables sequence component 304 to calculate a subsequent set of trajectories while servo component 306 integrates the current trajectory four times to produce a trajectory output vector 310 with position 318, velocity 320, acceleration 322, and jerk 324 components. Servo sample timing 308 determines the number of sample points in trajectory output vector 310 that servo component 306 provides over a time period.

Because the integrations performed by servo component 306 are linear, individual trajectories can be superimposed using vector addition. The ability to readily combine smaller and simpler individual trajectories greatly simplifies overall trajectory generation and reduces costs associated with generating and/or modifying the individual trajectories. In one implementation of the present invention, a pair of trajectories can be overlapped in time and added together to reduce turnaround time associated with a given trajectory. For example, a deceleration portion of one individual trajectory can be overlapped with the acceleration component of another trajectory to eliminate an unnecessary turnaround segment in between. In another implementation of the present invention, individual trajectories can be modified and then added together using vector addition creating trajectories with different contours and/or shapes as needed in addition to potentially reducing their turnaround times as described above.

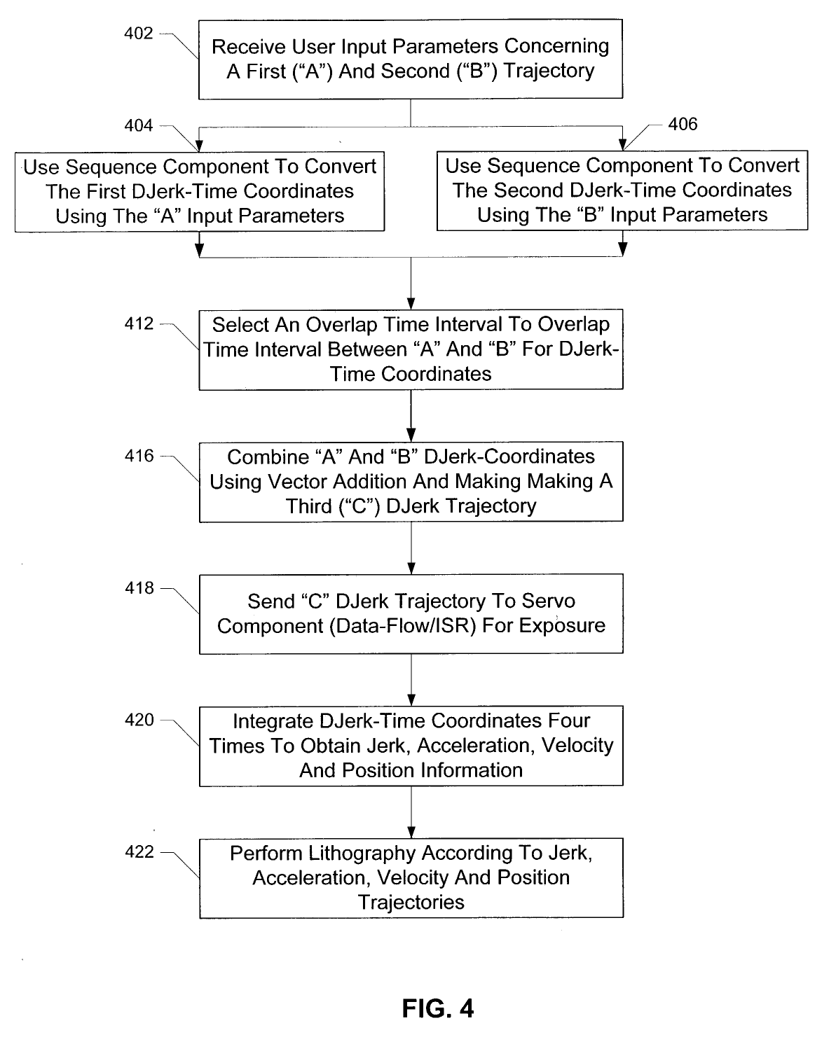

FIG. 4 is a flow chart diagram of the operations associated with combining individual trajectories into a resultant trajectory in accordance with one implementation of the present invention. Trajectories developed in accordance with implementations of the present invention can be used in semiconductor lithography applications as well as many other areas requiring precision manufacturing.

To generate the trajectory, a user initially provides first input parameters for a first trajectory (“A”) and second input parameters for a second trajectory (“B”) (402). In one implementation, the user provides these parameters interactively through a keyboard input device or specifies a file or multiple files containing the parameter information used by various implementations of the present invention. Alternatively, the user could be assisted in generating these parameters using one or more computer aided design (CAD) tools. In either of these implementations, an example set of first input parameters and second input parameters provided by the user may include: a maximum velocity, a maximum acceleration, a start position, a destination position, and a scanning length, as they relate to the trajectory as well as many other parameters useful in defining the trajectory.

Once gathered, the first input parameters of the first trajectory are converted into a first derivative-jerk (404) and the second input parameters of the second trajectory are converted into a second derivative-jerk (406). These conversions can be done in parallel, in sequence, or in any other manner deemed advantageous to improving throughput and/or efficiency.

As previously described, a sequence component portion in one implementation of the present invention handles the conversions and error checking separately from the servo component. This offloads processing requirements from the servo component as it directs or drives various stages of the lithographic equipment through a particular trajectory. Further, multiple buffers can be used to store the derivative-jerk values as they are calculated to make the trajectory values independently available to both the sequence component and the servo component as they perform various operations associated with the present invention. For example, the servo component can track a current trajectory while the sequence component is calculating a subsequent trajectory.

After the individual derivative-jerk values are determined, they can be modified and combined in accordance with implementations of the present invention. In one implementation, the first derivative-jerk is arranged to overlap in time with the second derivative-jerk by a time interval. This overlaps reduces the time period for individually performing the first trajectory and second trajectory (412). Alternatively, the first derivative jerk and the second derivative-jerk can be modified in many other ways before they are combined thereby altering specific characteristics of either the first trajectory or the second trajectory. For example, the first derivative-jerk and the second derivative-jerk can be modified and used to alter the shape and formation of each trajectory in addition to improving turnaround times and throughput.

Creating the trajectory involves combining the first derivative-jerk (“A”) and the second derivative-jerk (“B”) together into a third derivative-jerk (“C”) (416). In one implementation, each derivative-jerk has a corresponding vector. A first derivative-jerk-time vector corresponds to the first derivative-jerk and a second derivative-jerk-time vector corresponds to the second derivative-jerk. Vector addition is used to combine the first derivative-jerk (“A”) and the second derivative-jerk (“B”) during the lithographic exposure process.

The first derivative-jerk-time vector and the second derivative-jerk-time vector are each represented by a series of derivative-jerk and time value coordinate pairs as previously described. The vector addition combining these simpler underlying individual trajectories incrementally creates a larger more complex trajectory. As one benefit, this approach enables modifying and combining individual underlying trajectories without recalculating a complete trajectory or utilizing unwieldy and complex software routines or hardware. In one implementation, the first derivative-jerk and second derivative-jerk are overlapped and combined into a third derivative-jerk (“C”) to reduce the turnaround time between shots of exposure on the wafer or substrate. The resultant third derivative-jerk (“C”) is sent to the servo component for use during the subsequent exposure (418). The third derivative-jerk (“C”) also appears as a vector of derivative-jerk-time (DJerk-time) values generated as described previously.

In one implementation, servo component integrates the combined DJerk-time coordinates from the third derivative-jerk (“C”) at least four times to obtain Jerk, Acceleration, Velocity, and Position component information on the trajectory (420). For example, implementations of the present invention determine the jerk trajectory component of the resultant trajectory by integrating the derivative-jerk one time. Similarly, the acceleration component of the trajectory is identified by integrating the derivative-jerk two times; the velocity component of the trajectory is identified by integrating the derivative-jerk three times and the position component of the trajectory is identified by integrating the derivative-jerk four times. Each of these different trajectories (i.e., Jerk, Acceleration, Velocity, and Position) may include movement in multiple dimensions including an X axis, a Y axis, a Z axis, a Theta-X axis, a Theta-Y axis, a Theta-Z axis, and any other combinations thereof. The resulting vectors and information are processed and used to operate equipment performing lithography on semiconductor material or for other precision manufacturing applications (422).

FIG. 5A includes charts representing a derivative of Jerk (DJerk) and Jerk components for an example trajectory generated in accordance with one implementation of the present invention. In one implementation, DJerk can be specified using a vector containing a series of DJerk-time values indicated by the circles areas along the graph (502).

To improve throughput, a first derivative-jerk (“A”) is overlapped and combined with a second derivative-jerk (“B”) rather then connected end-to-end (502). In this example, a point along the first derivative-jerk (“A”) is selected (504) to connect to another point along the second derivative-jerk (“B”) (506) overlapping the first derivative-jerk (“A”) with the second derivative-jerk (“B”). The overlap is made between DJerk in the first derivative-jerk (“A”) as the trajectory decelerates and DJerk in the second derivative-jerk (“B”) as it accelerates over time. This modification and combination into the third derivative-jerk (“C”) (508) reduces the time spent between exposures based on the time interval between the two points (504 and 506) of the first and second derivative-jerks and as illustrated with respect to the third derivative-jerk (“C) (500). Likewise, comparing a first Jerk (“A”) and a second Jerk (“B”) in the end-to-end arrangement (510) and overlapped (516) as described above also reduces the processing time as illustrated by the interval between the two selected points (512 and 514).

FIG. 5B provides charts representing acceleration and velocity components associated with a trajectory generated in accordance with one implementation of the present invention. In FIG. 5B, a comparison between a first acceleration component (“A”) and a second acceleration component (“B”) in the end-to-end arrangement (518) and as a consequence of overlapping (524) also shows a time savings corresponding to a time interval between the selected points (520 and 522) of the two individual vectors and apparent in the third acceleration component (“C”). Likewise, first velocity component (“A”) and second velocity component (“B”) connected end-to-end (526) and overlapped (532) in accordance with implementations of the present invention also illustrate a time savings corresponding to the time interval between the points (528 and 530) and as seen in the third velocity component (532).

In FIG. 5C, a chart represents a position component of a trajectory generated in accordance with one implementation of the present invention. The chart in FIG. 5C demonstrates the time saved by generating the trajectory in accordance with the present invention. In this case, an end-to-end chart (534) shows a first position component (“A”) and a second position component (“B”) connected together and the overlap interval between the two selected points (536 and 538). By overlapping the first position component (“A”) and the second position component (“B”) as illustrated by the third position component (“C”) (540), trajectory time is reduced and throughput is improved.

The apparatus and method for generating trajectories provided herein is not only limited to microlithography for manufacturing semiconductor and microelectronic devices. Alternatively, for example, implementations of the present invention can be used with liquid-crystal-device (LCD) microlithography apparatus that exposes a pattern onto a glass plate for a liquid-crystal display. In another implementation, aspects of the present invention can be used by a micro lithography apparatus for manufacturing thin-film magnetic heads. In yet another alternative, for example, implementations of the present invention can be used by a proximity-microlithography apparatus for exposing a mask pattern wherein the mask and substrate are placed in close proximity with each other, and exposure is performed without having to use a projection-optical system.

Alternate implementations of the invention can also be used with any of various other apparatus and methods, including without limitation other microelectronic-processing apparatus, machine tools, metal-cutting equipment, and inspection apparatus. In any of various microlithography apparatus as described above, the energy source such as illumination light in an illumination-optical system can alternatively be a g-line source (438 nm), an i-line source (365 nm), a KrF excimer laser (248 nm), an ArF excimer laser (193 nm), or an F2 excimer laser (157 nm). This energy source can also be a charged particle beam such as an electron or ion beam, or a source of X-rays (including “extreme ultraviolet” radiation). If the energy source produces an electron beam, then the source can be a thermionic-emission type (e.g., lanthanum hexaboride or LaB6 or tantalum (Ta)) of electron gun. Using the electron beam, patterns can be transferred to a wafer from a reticle or directly to the wafer without the use of a reticle.

With respect to projection-optical system, if the illumination light comprises far-ultraviolet radiation, the constituent lenses are made of UV transmissive materials such as quartz and fluorite that readily transmit ultraviolet radiation. If the illumination light is produced by an F2 excimer laser or EUV source, then the lenses of projection-optical system can be either refractive or catadioptric, and reticle is reflective. If the illumination “light” is an electron beam (as a representative charged particle beam), then the projection-optical system typically includes various charged-particle-beam optics such as electron lenses and deflectors, and the optical path should be in a suitable vacuum. If the illumination light is in the vacuum ultraviolet (VUV) range (less than 200 nm), then projection-optical system can have a catadioptric configuration with beam splitter and concave mirror, as disclosed for example in U.S. Pat. Nos. 5,668,672 and 5,835,275, incorporated herein by reference.

Either or both a reticle stage and a wafer stage can include linear motors for moving reticle and wafer in the X axis and Y axis directions respectively. The linear motors can be air-levitation types (employing air bearings) or magnetic-levitation types (employing bearings based on the Lorentz force or a reactance force). Either or both of these stages can be configured to move along a respective guide or alternatively can be guideless. See U.S. Pat. Nos. 5,623,853 and 5,528,118, incorporated herein by reference.

Moreover, alternate implementations using a reticle stage or a wafer stage can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage.

Movement of a reticle stage and wafer stage as described herein can generate reaction forces that can affect the performance of the micro lithography apparatus. Reaction forces generated by motion of wafer stage can be shunted to the floor (ground) using a frame member as described, e.g., in U.S. Pat. No. 5,528,118, incorporated herein by reference. Reaction forces generated by motion of reticle stage 508 can also be shunted to the floor (ground) using a frame member as described in U.S. Pat. No. 5,874,820, incorporated herein by reference.

A microlithography apparatus such as any of the various types described can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical system components and assemblies are adjusted as required to achieve maximal optical accuracy. Similarly, mechanical and electrical systems are adjusted as required to achieve maximal respective accuracies. Assembling the various subsystems into a micro lithography apparatus requires the making of mechanical interfaces, electrical-circuit wiring connections, and pneumatic plumbing connections as required between the various subsystems. Typically, constituent subsystems are assembled prior to assembling the subsystems into a microlithography apparatus. After assembly of the apparatus, system adjustments are made as required to achieve overall system specifications in accuracy, etc. Assembly at the subsystem and system levels desirably is performed in a clean room where temperature and humidity are controlled.

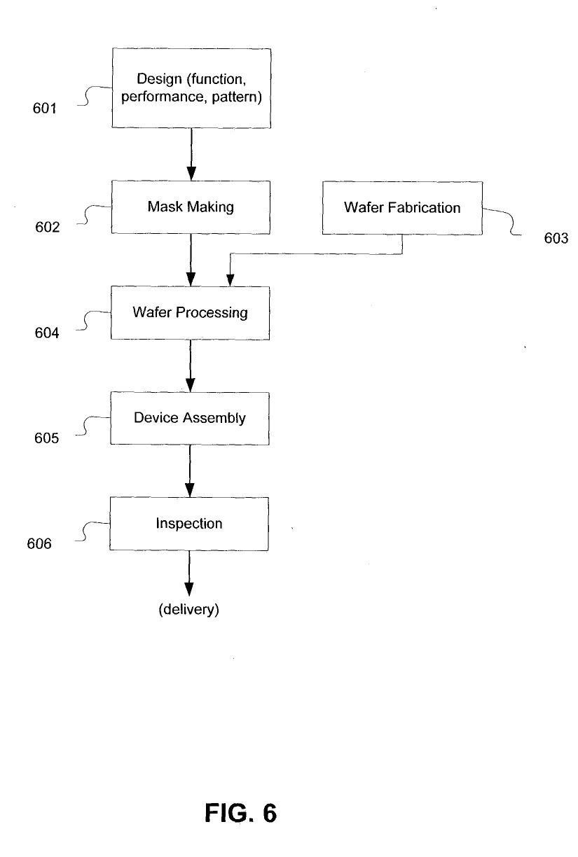

FIG. 6 depicts additional steps in a flow-chart diagram format covering the device design and delivery of the final product in addition to wafer fabrication described above using implementation of the present invention. Initially, the device's function and performance characteristics are designed (601). Next, a pattern is designed according to the previous designing step to make a mask (reticle) for creating a wafer (602). In parallel, a wafer or other suitable substrate is made (603). The mask pattern designed as described is exposed onto the wafer (604) by a photolithography system described hereinabove and using a trajectory generated in accordance with the present invention. Once microlithography is complete, the semiconductor device is assembled (605) (including the dicing process, bonding process and packaging process), and then finally the device is inspected (606).

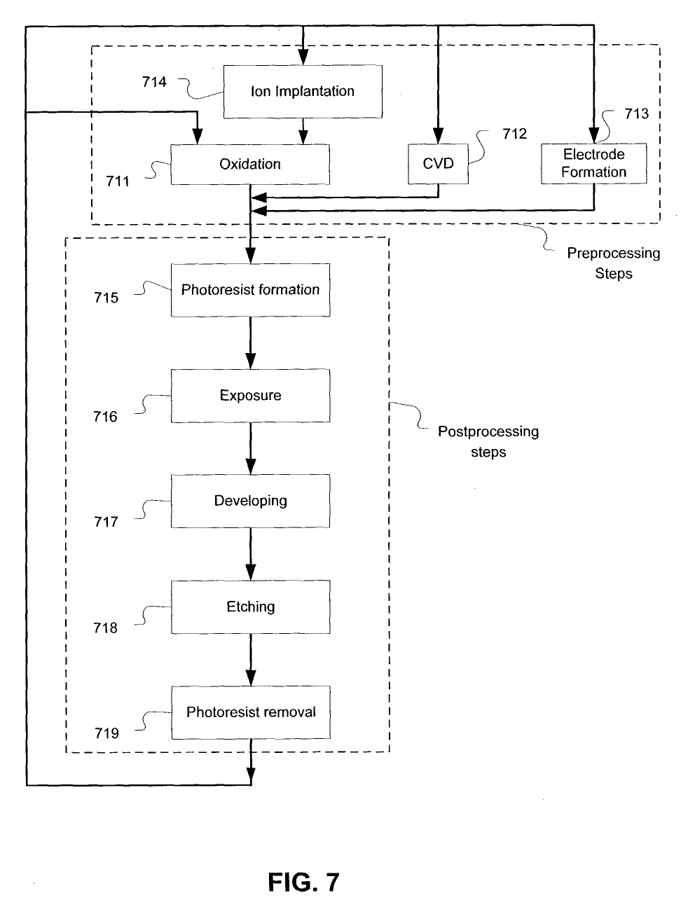

FIG. 7 is a flow chart diagram further detailing the operations associated with fabricating semiconductor devices in accordance with implementations of the present invention. Initially, the wafer surface is oxidized (711) and using chemical vapor deposition (CVD) an insulation film is formed on the wafer surface (712). Electrodes are formed on the wafer by vapor deposition (electrode formation) (713) and ions are implanted in the wafer (ion implantation) (714). Process elements 711-714 constitute the “preprocessing” for wafers during wafer processing; during these different operations selections are made according to the particular processing requirements.

The following post-processing operations in the flow chart in FIG. 7 are implemented when the above-mentioned preprocessing operations have been completed. During post-processing, photoresist is applied to a wafer (photoresist formation), (715) and the above-mentioned exposure device transfers the circuit pattern of a mask (reticle) to a wafer (exposure operation) (716). Next, the exposed wafer is developed (development operation) (717) and exposed material surface other than residual photoresist is removed by etching (etching operation) (718). Lastly, unnecessary photoresist remaining after etching is removed (photoresist removal operation) (719).

Multiple circuit patterns are formed by repetition of these preprocessing and post-processing operations. It is to be understood that a photolithographic instrument may differ from the one shown herein without departing from the scope of the present invention. For example, implementations of the present invention are described as combining pairs of smaller trajectories however, more than two trajectories may also be combined together to create a trajectory. Also, fourth-order position trajectories are described above when generating a trajectory from individual trajectories however, alternate implementations of the present invention can be applied to higher or lower order position trajectories as well. It is also to be understood that the application of the present invention is not to be limited to a wafer processing apparatus. While embodiments of the present invention have been shown and described, changes and modifications to these illustrative embodiments can be made without departing from the present invention in its broader aspects, described in the appended claims. Accordingly, the invention is not limited to the above-described implementations, but instead is defined by the appended claims in light of their full scope of equivalents.

1. A method for generating a trajectory used in precision lithography, comprising:
receiving first input parameters for a first trajectory and second input parameters for a second trajectory;
converting the first input parameters of the first trajectory into a first derivative-jerk and the second input parameters of the second trajectory into a second derivative-jerk;
arranging the first derivative-jerk to overlap the second derivative-jerk by a time interval and reduce the time period for performing the first trajectory and second trajectory; and
combining the first derivative-jerk and the second derivative-jerk together into a third derivative-jerk using a smaller time interval than required separately by the first derivative-jerk and the second derivative-jerk.

2. The method of claim 1 further comprising determining a combined trajectory associated with the third derivative-jerk by integrating the third derivative-jerk one or more times.

3. The method of claim 1 further comprising modifying the first derivative-jerk and modifying the second derivative-jerk before they are combined to alter individual aspects of the first trajectory and second trajectory.

4. The method of claim 1 wherein the first input parameters for the first trajectory and second input parameters for the second trajectory relate to the shape and formation of each respective trajectory.

5. The method of claim 4 wherein the first input parameters and second input parameters related to the trajectory include one or more values selected from a group of values including: a maximum velocity, a maximum acceleration, a start position, a destination position, and a scanning length.

6. The method of claim 1 wherein the converting further includes creating a first derivative-jerk-time vector corresponding to the first derivative-jerk and creating a second derivative-jerk-time vector corresponding to the second derivative-jerk set of coordinate pairs.

7. The method of claim 6 wherein the first derivative-jerk-time vector and the second derivative-jerk-time vector are each represented by a series of derivative-jerk and time value coordinate pairs.

8. The method of claim 1 wherein combining the first derivative-jerk and the second derivative-jerk is performed using vector addition.

9. The method of claim 8 wherein the vector addition of the first derivative-jerk and the second derivative-jerk creates the trajectory incrementally during lithographic processing.

10. The method of claim 1 wherein a jerk trajectory component of the trajectory is identified by integrating the derivative-jerk one time.

11. The method of claim 1 wherein an acceleration component of the trajectory is identified by integrating the derivative-jerk two times.

12. The method of claim 1 wherein a velocity component of the trajectory is identified by integrating the derivative-jerk three times.

13. The method of claim 1 wherein a position component of the trajectory is identified by integrating the derivative-jerk four times.

14. The method of claim 1 wherein the trajectory may include movement in multiple dimensions including an X axis, a Y axis, a Z axis, a Theta-X axis, a Theta-Y axis, a Theta-Z axis, and any other combinations thereof.

15. A method for generating a trajectory to drive a stage, comprising:
receiving first input parameters for a first trajectory and second input parameters for a second trajectory;
converting the first input parameters of the first trajectory into a first derivative-jerk and the second input parameters of the second trajectory into a second derivative-jerk;
combining the first derivative-jerk and the second derivative-jerk together into a third derivative-jerk corresponding to a modified version of the first trajectory and the second trajectory; and
determining a combined trajectory associated with the third derivative-jerk by integrating the third derivative-jerk one or more times.

16. The method of claim 15 further comprising overlapping the first derivative-jerk and the second derivative-jerk by a time interval before they are combined to reduce the time period for individually performing the first trajectory and second trajectory.

17. The method of claim 15 further comprising modifying the first derivative-jerk and modifying the second derivative-jerk before they are combined to alter individual characteristics of the first trajectory and second trajectory.

18. The method of claim 15 wherein the first input parameters for the first trajectory and second input parameters for the second trajectory relate to the shape and formation of each respective trajectory.

19. The method of claim 18 wherein the first input parameters and second input parameters include one or more values related to the trajectory and selected from a group of values including: a maximum velocity, a maximum acceleration, a start position, a destination position, and a scanning length.

20. The method of claim 15 wherein the converting further includes creating a first derivative-jerk-time vector corresponding to the first derivative-jerk and creating a second derivative-jerk-time vector corresponding to the second derivative-jerk set of coordinate pairs.

21. The method of claim 20 wherein the first derivative-jerk-time vector and the second derivative-jerk-time vector are each represented by a series of derivative-jerk and time value coordinate pairs.

22. The method of claim 15 wherein combining the first derivative-jerk and the second derivative-jerk is performed using vector addition.

23. The method of claim 22 wherein the vector addition of the first derivative-jerk and the second derivative-jerk creates the trajectory incrementally during processing.

24. The method of claim 15 wherein the trajectory may include movement in multiple dimensions including an X axis, a Y axis, a Z axis, a Theta-X axis, a Theta-Y axis, a Theta-Z axis, and any other combinations thereof.

25. The method of claim 15 wherein the stage is used in the lithographic processing of semiconductor material.

26. An exposure apparatus that exposes a substrate during processing, comprising:
an energy emission system that forms an image on a substrate;
a substrate stage that supports the substrate and moves the substrate along one or more axes relative to the energy emission system;
an actuator operatively connected to the substrate stage that moves the substrate stage in response to controller signals corresponding to a trajectory;
a controller operatively connected to the actuator that generates the trajectory by receiving first input parameters for a first trajectory and second input parameters for a second trajectory, converting the first input parameters of the first trajectory into a first derivative-jerk and the second input parameters of the second trajectory into a second derivative-jerk, and combining the first derivative-jerk and the second derivative-jerk together into a third derivative-jerk that modifies the first trajectory and the second trajectory.

27. The apparatus of claim 26 wherein the controller further determines a combined trajectory associated with the third derivative-jerk by integrating the third derivative-jerk one or more times.

28. The apparatus of claim 26 wherein the controller further overlaps the first derivative-jerk and the second derivative-jerk by a time interval before they are combined to reduce the time period for individually performing the first trajectory and second trajectory.

29. The apparatus of claim 26 wherein the controller further modifies the first derivative-jerk and modifies the second derivative-jerk before they are combined to alter individual characteristics of the first trajectory and second trajectory.

30. The apparatus of claim 26 wherein the first input parameters for the first trajectory and second input parameters for the second trajectory relate to the shape and formation of each respective trajectory.

31. The apparatus of claim 26 wherein the first input parameters and second input parameters include one or more values related to the trajectory and selected from a group of values including: a maximum velocity, a maximum acceleration, a start position, a destination position, and a scanning length.

32. The apparatus of claim 26 wherein the converting further includes creating a first derivative-jerk-time vector corresponding to the first derivative-jerk and creating a second derivative-jerk-time vector corresponding to the second derivative-jerk set of coordinate pairs.

33. The apparatus of claim 32 wherein the first derivative-jerk-time vector and the second derivative-jerk-time vector are each represented by a series of derivative-jerk and time value coordinate pairs.

34. The apparatus of claim 26 wherein the controller uses vector addition when combining the first derivative-jerk and the second derivative-jerk.

35. The apparatus of claim 26 wherein the vector addition of the first derivative-jerk and the second derivative-jerk is used to create the trajectory incrementally during processing.

36. The apparatus of claim 26 wherein the trajectory may include movement in multiple dimensions including an X axis, a Y axis, a Z axis, a Theta-X axis, a Theta-Y axis, a Theta-Z axis, and any other combinations thereof.

37. The apparatus of claim 26 wherein the stage is used in the lithographic processing of semiconductor material.

38. An apparatus for generating a trajectory used in precision lithography, comprising:
means for receiving first input parameters for a first trajectory and second input parameters for a second trajectory;
means for converting the first input parameters of the first trajectory into a first derivative-jerk and the second input parameters of the second trajectory into a second derivative-jerk;
means for arranging the first derivative-jerk to overlap the second derivative jerk by a time interval and reduce the time period for performing the first trajectory and second trajectory; and
means for combining the first derivative-jerk and the second derivative-jerk together into a third derivative-jerk using a smaller time interval than required separately by the first derivative-jerk and the second derivative-jerk.
